(19) United States
(12) Patent Application Publication
(10) Pub. No.: US 2004/0026828 A1
(43) Pub. Date: Feb. 12, 2004

(54) Equipment and process for producing a molded article

(76) Inventor: Hans-Georg Seimetz, Wadern-Wadrill (DE)

Correspondence Address: Friedrich Kueffner, Suite 910, 317 Madison Avenue, New York, NY, 10017, US

(21) Appl. No.: 10/607,846

(22) Filed: Jun. 27, 2003

(30) Foreign Application Priority Data
Jun. 29, 2002 (DE) 102 29 297.3

(51) Int. Cl. B29C 43/02

(52) U.S. Cl. 264/319; 264/449; 425/167; 425/407; 425/412

(57) ABSTRACT

A process and equipment for producing a molded article, especially from a carbon molding compound that has been treated with carbon fibers and contains a thermosetting binder, wherein the molded article is hardened by heating in a press mold under pressure. The molded article is heated by itself by electric resistance heating.

### BACKGROUND OF THE INVENTION

1. Field of the Invention

The present invention relates to a process for producing a molded article, especially from a carbon molding compound that has been treated with carbon fibers and contains a thermosetting binder, in which the molded article is hardened by heating in a press mold under pressure.

In addition, the invention relates to equipment for carrying out the process, which consists of a press mold with a die, with at least one ram and with one counterpart to the ram in a press frame, especially with the intermediate installation of a mounting fixture.

2. Description of the Related Art

A process of this type and equipment of this type are used in the state of the art for producing ceramic brake disks from carbon molding compounds that have been treated with carbon fibers and contain thermosetting binders. The cured binders are later carbonized by a heat treatment in a nonoxidizing atmosphere; in most cases, the carbon molding compound is then partially or completely converted to silicon carbide by infiltration of liquid silicon into the porous body and another heat treatment, with retention of the carbon fibers.

The first heating, still under pressure in the press mold, is carried out for the purpose of curing the binders in any event to a sufficient extent that the compressed molding compound (which, however, shows a tendency to separate due to its fiber content) is sufficiently hardened that the molded article can be further treated.

The binders are generally thermosetting resins, such as phenol resins. The first heating for hardening the binder reaches, e.g., 170-180° C. or higher. The solidification begins at about 135° C. The carbonization is carried out at about 750-1,100° C. To be able to carry out the heating in the press mold, the press mold is provided with a heatable lower ram and a heatable upper ram. The flat molded article between the rams, i.e., two half disks have been compressed and then put together, hardens in about 45 minutes.

### SUMMARY OF THE INVENTION

The object of the invention is to accelerate the hardening.

In accordance with the invention, this object is achieved by heating the molded article itself by electric resistance heating.

The equipment of the invention is characterized by the fact that opposing parts of the press mold are electrically insulated at least from the press frame and are connected to a current source.

The curing time of the brake disk molded article referred to above can be reduced in this way to 10 to 15 minutes, and, furthermore, this is for the case of a molded article compressed as a single piece.

At the same time, the structure of the molded article remains more uniform than in the case of heat transfer from the rams, since the molded article heats everywhere simultaneously and thus softens uniformly.

As a rule, the specified parts of the press mold will be a ram and its counterpart, especially an upper ram and a lower ram.

If, in addition to the die that is always present, the press mold has a mandrel for producing a ring-shaped molded article, then, in principle, current flow could also be produced between the die and the mandrel instead of between the ram and its counterpart.

The above-mentioned insulation of the parts connected with the current source is preferably already installed for insulation from the mounting fixture, which is usually called the “adapter”.

Other parts of the press mold are likewise insulated at least from the press frame, preferably already from the adapter, or the adapter is insulated in itself to that extent. As far as possible, the other parts also in the press mold could be insulated from the parts connected to the current source and from the molding compound, for example, by abrasion-resistant ceramic coatings.

An especially advantageous and effective embodiment of the invention consists in a press mold for producing a molded article, especially a flat molded article, which has cavities and, between the cavities, webs, which essentially join the two disks, with the use of at least one removable core. In this press mold, a lower ram and an upper ram constitute the aforesaid parts that are connected to the current source, and in each of these rams, a segment ram is integrated, which is preferably not connected to the current source and has ram segments with essentially the cross-sectional shape of the above-mentioned webs, with which ram segments the segment ram moves into and engages recesses with the same cross-sectional shape in the lower ram or upper ram. The core has core segments that form the above-mentioned cavities, and the spaces of the core segments are arranged in the press mold congruently with the ram segments.

With this arrangement, the current is not introduced via the webs, through which, in any case, it must pass if the core is nonconductive, but rather in the regions next to them, which are thus also fully covered by the current flow. This conduction of the current flow can be achieved especially completely with a narrow, elongated cross section of the webs and the cavities in the form of channels of the type found in annular molded brake disks, which have ventilation channels for cooling, which pass through from the inner circumference to the outer circumference of the disk. The above-mentioned simultaneous heating and softening and the resulting uniformity of the structure of the molded article are especially advantageous in the case of the molded articles with the cavities and webs.

The nonconductive, destroyable core preferably consists of a pyrolyzable thermoplastic, whose melting point is above the curing temperature of the specified binder. The thermoplastic can be melted out of the molded article in the course of the carbonization treatment and collected, e.g., at 250-280° C. The collected amount is pyrolyzed separately at higher temperatures.

A core that can be removed from the molded article by pulling it apart would consist, for example, of aluminum or steel. Its parts could be detachably connected on the outer and inner circumference of the ring-shaped core and possibly also in the interior and could be removed towards the outside and towards the inside. The design of the cavities could be slightly altered and adapted for this purpose. The parts of the core may be provided with an insulating coating, if the core is to be nonconductive. However, it was found that sufficient heating is also possible with a conductive core made of aluminum. The core heats itself and heats the webs enclosed by it by heat transfer.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 shows an isometric drawing of a molded ceramic brake disk;

FIG. 2 shows the lower section of a piece of press equipment and a press mold in vertical section;

FIG. 3 shows the upper section of the press equipment and the press mold in vertical section, and

FIG. 4 shows a core in top view.

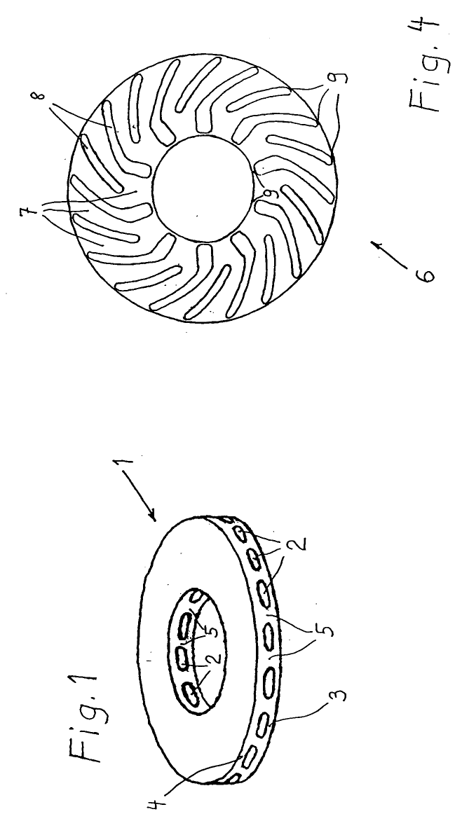

### DETAILED DESCRIPTION OF THE INVENTION

The molded article to be produced is labeled 1. It has a flat-annular shape. In its center with respect to the thickness of the disk, channels 2 run from the inner circumference to the outer circumference. Accordingly, the molded article consists essentially of two disks 3 and 4, which are connected by webs 5 remaining between the channels 2.

The shape of the channels 2 and webs 5 is evident from FIG. 4. The core 6 shown in FIG. 6 has the channels 2 in the form of core segments 7 and the webs 5 in the form of spaces 8. The core segments 7 are connected on the inner circumference and on the outer circumference by narrow ring segments 9.

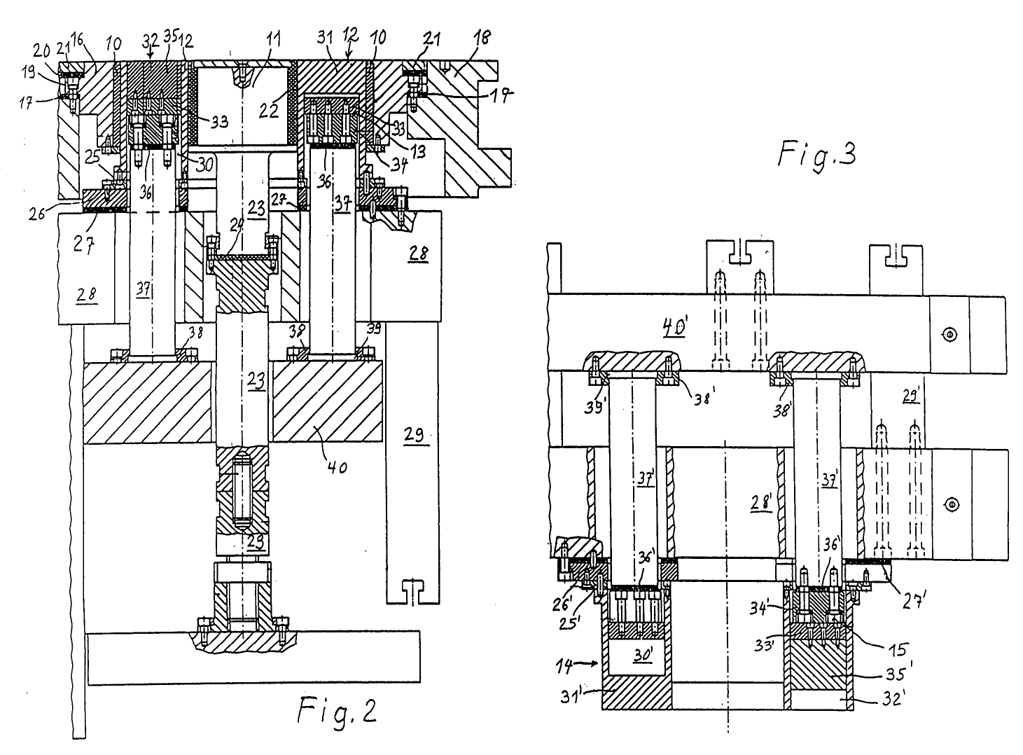

The press mold used to produce the molded article 1 consists of a die 10, a mandrel 11, a lower ram 12, a lower segment ram 13, an upper ram 14, and an upper segment ram 15. Parts 10 to 13 appear in FIG. 2, and parts 14 and 15 appear in FIG. 3.

The die 10 has the form of a flat hollow cylinder and forms the outer wall of the press mold. It is mounted as a stationary part. It is seated in a supporting ring 16 in the manner shown in the drawing. The supporting ring is supported in the stationary die table with an interposed insulating disk 17 for electrical insulation. The screw joint 19 for this is covered by another insulating disk 20 and a ring 21 that closes the surface of the table.

As the counterpart to the die 10, the mandrel 11 forms the inner wall of the ring-shaped press mold at the same height as the die. It is designed as a cylinder consisting of solid material with a wear-resistant outer jacket 22. It is also mounted as a stationary part, namely, on a multiply composed column 23 with electrical insulation by an insulating plate 24 installed between two sections of the column.

The lower ram 12 fills the ring cross section between the die 10 and the mandrel 11 and can be moved up and down in it. It is supported on a plate 28 of the press by a union ring 25, a power supply plate 26, and an insulating disk 27, and is screwed together with the plate 28 of the press, which is connected by columns 29 with the lower ram of the press. The lower ram 12 is made of solid material. Along the lower, larger portion of its height, it has an annular cavity 30. In the solid material 31 stopped above it, vertical shafts 32 that pass through it are worked out. In horizontal cross section, the shafts 32 have the same arrangement and more or less the same shape as the spaces 8 in the core 6.

The lower segment ram 13 consists of two rings 33 and 34 made of solid material, which are screwed together, and of ram segments 35 that are placed on the upper ring 33 and screwed together with it. The lower ring 34 is supported on four columns 37 with interposed insulating plates 36 and screwed together with the columns 37. The columns 37 stand on another plate 40 of the press with bases 39 that are overlapped by a supporting ring 38. The plate 40 is connected with another lower ram of the press.

The rings 33 and 34 have room in the cavity 30 of the lower ram 12. The segments 35 project into the shafts 32 and fill their cross section. In the lower end position of the segment ram 15, they form a base that closes the shafts 32 towards the bottom, and in the upper position, they stop flush with the surface of the lower ram. This position is shown in FIG. 2.

The upper ram 14 and the upper segment ram 15 are designed and arranged with mirror symmetry to the lower ram 12 and the lower segment ram 13. The parts of the upper ram 14 and the upper segment ram 15, which correspond to parts 25 to 40, are labeled with the same reference numbers except for the addition of ′. The only differences are that the columns 29′ and 37′ are smaller than the columns 29 and 37 and are connected with the upper rams of the press.

The power supply plates 26 and 26′ are connected to connections (not shown), each of which has a large number of power supply lines, which are able to follow the movements of the lower ram 12 or upper ram 14.

The parts 16, 18, 23, 28, 29, 37-40, 28′, 29′, and 37′-40′ are parts of an adapter, by which the press mold 10-15 is mounted, in a way that is already well known, in a press frame with two lower rams and two upper rams as well as slide valves for the molding compound.

Molding compound is introduced with the lower ram 12 drawn back relative to the upper surface of the die 10 and with the lower segment ram 13 drawn back relative to the upper surface of the lower ram 12. During this filling operation, additional molding compound is also introduced into the shafts 32 in the lower ram 12 at the location of the webs 5 that are to be formed. The lower ram 12 and the lower segment ram 13 are then drawn back further, and the core is inserted, such that the spaces 8 of the core segments 7 are arranged congruently with the aforesaid ram segments 35. After the lower ram 12 and the lower segment ram 13 have been drawn back still farther, more molding compound is introduced. The spaces of the core segments are also filled in this operation.

The upper ram 14 and the upper segment ram 15 are later lowered and placed on the molding compound. Then, as the upper segment ram 15 is drawn back, the lower segment ram 13 is advanced until the ram segments 35, 35′ in the lower ram 12 and in the upper ram 14 are at essentially the same distance from the ram surface. Columns of material are thus moved upward within the filling, essentially still without compression, namely, from the shafts 32 in the lower ram 12 into the spaces 8 of the core segments 7 and from these into the respective shafts 32′ of the upper ram. At the end of this step, essentially the same amount of molding compound is present in the shafts 32, 32′ above the core 6 as below the core. The segment rams 13, 15 are then advanced until the surfaces of the ram segments 35, 35′ are flush with the surfaces of the rams. Then or partly or completely during this operation, the lower ram 12 and the upper ram 14 are advanced to their end positions.

In this state, the molded article is heated by applying an alternating voltage of, for example, 2-3 V between the power supply plates 26 and 26′. The current flows from the power supply plate 26 into the lower ram 12, from this into the lower disk 3 of the molded article 1, then through the webs 5 of the molded article 1 that are formed in the spaces 8 of the non-conducting core 6, from these into the upper disk 4 of the molded article 1, and then further through the upper ram 14 and its power supply plate 26′, or in the opposite direction. If the core 6 were made of metal or some other conductive material, it would, as was found, itself heat up and then heat the webs 5 enclosed by it, by heat transfer. With the selection of material specified above, i.e., carbon molding compounds that are treated with carbon fibers and contain binders consisting of pitches and/or thermosetting resins, the molding compound 43 and the friction lining compound 41 have a conductivity that allows them to be sufficiently heated, and the binders have the ability, when heated, to cure to the extent that the compressed molding compound (which, however, shows a tendency to separate due to its fiber content) is sufficiently hardened that the molded article 1 can be further treated. The current intensity that develops at the applied voltage of 2-3 V varies within wide limits due to the changes within the molded article. It may rise to as high as 15,000 A, especially at the beginning, and later fall back to as low as 100 A. The heating is controlled by interval control, starting with a temperature measurement by a thermocouple pushed forward from the mandrel 11 into one of the webs 5.

The hardened molded article 1 is ejected from the press mold.

The core 6 is later destroyed in the manner described earlier.

Instead of the complete molded brake disks described above, the above-mentioned half disks produced by state-of-the-art processes as well as a wide variety of other molded articles could be compressed and hardened in accordance with the invention and then joined later.

It would also be conceivable to produce the current for heating the molded article in itself by induction in the molded article. For example, an eddy current could be induced by a field rotating in or on the die.

While specific embodiments of the invention have been shown and described in detail to illustrate the inventive principles, it will be understood that the invention may be embodied otherwise without departing from such principles.

I claim:

1. A process for producing a molded article, especially from a carbon molding compound which is treated with carbon fibers and contains a thermosetting binder, the process comprising hardening the molded article by heating the molded article in a press mold under pressure, further comprising heating the molded article itself by electric resistance heating.

2. An equipment for producing a molded article, especially from a carbon molding compound which is treated with carbon fibers and contains a thermosetting binder, the equipment comprising
a press mold mounted in a press frame, especially with an intermediate arrangement of an adapter, wherein
opposing parts of the press mold are electrically insulated at least from the press frame and are connected to a current source.

3. The equipment according to claim 2, wherein the opposing parts of the press mold are an upper ram and a lower ram.

4. The equipment according to claim 2, wherein the opposing parts are insulated from the adapter, or the adapter is insulated in itself.

5. The equipment according to claim 2, wherein other parts of the press mold are insulated at least from the press frame and from the adapter, or the adapter is insulated in itself.

6. The equipment according to claim 2, wherein other parts of the press mold are insulated in the press mold from the opposing parts and from the molding compound.

7. The equipment according to claim 2, wherein the press mold is configured for producing a molded article, especially a flat molded article, with cavities and webs between the cavities, and with disks essentially joined by the webs, further comprising at least one removable core, wherein the opposing parts are a lower ram and an upper ram, wherein a segment ram is integrated in each of the upper and lower rams, wherein the segment rams are not connected to the current source, wherein the segment rams have ram segments having essentially the same cross-sectional shape as the webs, wherein the segment rams move ram segments into and engage recesses having the same cross-sectional shape in the lower ram or the upper ram, wherein the core has core segments forming the cavities, and wherein spaces of the core segments are arranged in the press mold congruently with the ram segments.

8. The equipment according to claim 7, wherein the core is comprised of an electrically non-conductive material, wherein the material is destroyable by heating.

9. The equipment according to claim 7, wherein, for connecting the rams with the current source, each ram comprises a ring having a large number of cable connections distributed over the circumference thereof, wherein the ram is mounted on the ring, and the ring is mounted on the adapter and is insulated therefrom.
